(19) United States
(12) Patent Application Publication
(10) Pub. No.: US 2020/0151963 A1
(43) Pub. Date: May 14, 2020

(54) TRAINING DATA SET GENERATION APPARATUS AND METHOD FOR MACHINE LEARNING

(71) Applicant: Electronics and Telecommunications Research Institute, Daejeon (KR)

(72) Inventors: Seung-Wook LEE, Daejeon (KR); Tae-Joon KIM, Sejong-si (KR); Seung-Uk YOON, Daejeon (KR); Seong-Jae LIM, Daejeon (KR); Bon-Woo HWANG, Daejeon (KR); Jin-Sung CHOI, Daejeon (KR)

(73) Assignee: Electronics and Telecommunications Research Institute, Daejeon (KR)

(21) Appl. No.: 16/557,726

(22) Filed: Aug. 30, 2019

(30) Foreign Application Priority Data
Nov. 12, 2018 (KR) 10-2018-0138479

(51) Int. Cl. G06T 19/20; G06N 20/00; G06T 17/00; G06T 15/20; G06T 7/149; G06T 15/04

(52) U.S. Cl. CPC G06T 19/20; G06N 20/00; G06T 17/00; G06T 2219/2016; G06T 7/149; G06T 15/04; G06T 2207/20081; G06T 15/20

(57) ABSTRACT

Disclosed herein are an apparatus and method for generating a training data set for machine learning. The method for generating a training data set, performed by the apparatus for generating the training data set for machine learning, includes generating a 3D model for a deformed 3D character based on 3D data pertaining to the 3D character, generating a 2D image corresponding to the 3D model, and generating the training data set for machine learning, through which the 3D character is generated from the 2D image, using the 2D image and the 3D model.

### CROSS REFERENCE TO RELATED APPLICATION

This application claims the benefit of Korean Patent Application No. 10-2018-0138479, filed Nov. 12, 2018, which is hereby incorporated by reference in its entirety into this application.

### BACKGROUND OF THE INVENTION

### 1. Technical Field

The present invention relates generally to technology for generating a training data set for machine learning, and more particularly to technology for generating a training data set for machine learning through which a three-dimensional (3D) character is generated using a two-dimensional (2D) image.

### 2. Description of the Related Art

Deep learning provides outstanding performance in various application fields, compared to traditional computer-vision approaches using handcrafted features. In deep learning, convolutional neural networks are applied in various fields, such as image recognition, natural-language processing, games, and the like, and achieve excellent results.

Existing learning methods based on convolutional neural networks require a large amount of training data. Training data such as images or sounds may be obtained using a simple method, but it is difficult to obtain a large amount of training data for 3D deep learning. Recently, with the development of 3D vision technology, affordable 3D data acquisition devices have become widespread, but it is still difficult to acquire a large amount of 3D data.

In particular, supervised learning requires labelled information. For example, in order to create a 3D character to be used in the fields of gaming, animation, VR/AR, and the like, it is necessary to undertake the steps of an existing graphics pipeline, configured such that a key animator draws an original painting in the form of a 2D image, a 3D modeler performs modeling based thereon, and a 3D character is created by performing a texture-mapping process, a rigging process, an animation process, and the like. Also, the existing vision methods acquire multi-view images for an object and reconstruct a 3D character using information about the positions of cameras used when the multi-view images are acquired.

### DOCUMENTS OF RELATED ART

(Patent Document 1) Korean Patent Application Publication No. 10-2017-0074413, published on Jun. 30, 2017 and titled “2D image data generation system using 3D model and method thereof”.

### SUMMARY OF THE INVENTION

An object of the present invention is to generate a large training data set by expanding a small amount of seed data in order to acquire a large training data set for machine learning.

Another object of the present invention is to automatically create a 3D character based on an original 2D drawing.

In order to accomplish the above objects, a method for generating a training data set, performed by an apparatus for generating the training data set for machine learning, according to the present invention includes generating a 3D model for a deformed 3D character based on 3D data pertaining to the 3D character; generating at least one 2D image corresponding to the generated 3D model; and generating the training data set for machine learning, through which the 3D character is generated from the 2D image, using the 2D image and the 3D model.

Here, generating the 3D model for the deformed 3D character may be configured to segment the 3D data into multiple segment models and to deform the segment models, thereby generating a deformed 3D model of the 3D character.

Here, generating the 2D image may be configured to perform multi-view rendering on the 3D model, thereby generating the at least one 2D image corresponding to the 3D model.

Here, generating the 3D model for the deformed 3D character may include segmenting the 3D data into multiple segment models; generating at least one deformed model by deforming at least one of the segment models; and generating the 3D model so as to correspond to the deformed 3D character using the segment models including the at least one deformed model.

Here, segmenting the 3D data into the multiple segment models may be configured to classify the 3D data based on multiple parts of the 3D character and to generate the segment models for the respective parts by segmenting the 3D data into the segment models so as to match the multiple parts.

Here, generating the at least one deformed model may be configured to generate the deformed model by modifying at least one of the size and the pattern of the part of the 3D character.

Here, generating the 3D model so as to correspond to the deformed 3D character may be configured to generate the single 3D model by combining the segment models including the at least one deformed model and to augment the generated single 3D model, thereby generating an augmented 3D model.

Here, generating the 3D model for the deformed 3D character may be configured to augment the 3D model using skinning information when the 3D data is mapped to a dummy model corresponding to the 3D character through skinning.

Here, generating the 3D model for the deformed 3D character may be configured to augment the 3D model by applying 2D augmentation to the texture of the 3D model.

Here, generating the 2D image may be configured to generate the 2D image corresponding to the 3D model by performing texture-preprocessing on the 3D model and by applying Cel Shading to the 3D model on which texture-preprocessing is performed.

Also, an apparatus for generating a training data set for machine learning according to an embodiment of the present invention includes a 3D model extension unit for generating a 3D model for a deformed 3D character based on 3D data pertaining to the 3D character; a 2D image generation unit for generating at least one 2D image corresponding to the generated 3D model; and a training data set generation unit for generating the training data set for machine learning, through which the 3D character is generated from the 2D image, using the 2D image and the 3D model.

Here, the 3D model extension unit may segment the 3D data into multiple segment models and generate a deformed 3D model of the 3D character by deforming the segment models.

Here, the 2D image generation unit may perform multi-view rendering on the 3D model, thereby generating the at least one 2D image corresponding to the 3D model.

Here, the 3D model extension unit may include a 3D data analysis module for segmenting the 3D data into multiple segment models; a deformation module for generating at least one deformed model by deforming at least one of the segment models; and a combination module for generating the 3D model corresponding to the deformed 3D character using the segment models including the at least one deformed model.

Here, the 3D data analysis module may classify the 3D data based on multiple parts of the 3D character and segment the 3D data into the segment models so as to match the multiple parts, thereby generating the segment models for the respective parts.

Here, the deformation module may generate the deformed model by modifying at least one of the size and the pattern of the part of the 3D character.

Here, the 3D model extension unit may further include an augmentation module for generating an augmented 3D model by augmenting the 3D model, which is generated in such a way that the combination module combines the segment models including the at least one deformed model.

Here, the 3D model extension unit may augment the 3D model using skinning information when the 3D data is mapped to a dummy model corresponding to the 3D character through skinning.

Here, the 3D model extension unit may augment the 3D model by applying 2D augmentation to the texture of the 3D model.

Here, the 2D image generation unit may generate the 2D image corresponding to the 3D model by performing texture-preprocessing on the 3D model and by applying Cel Shading to the 3D model, on which texture-preprocessing is performed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view schematically shows an environment in which an apparatus for generating a training data set for machine learning according to an embodiment of the present invention is applied;

FIG. 2 is a view that shows a supervised learning process for generating a 3D character from an original 2D drawing;

FIG. 3 is a block diagram that shows the configuration of an apparatus for generating a training data set for machine learning according to an embodiment of the present invention;

FIG. 4 is a block diagram that shows the configuration of a 3D model extension unit according to an embodiment of the present invention;

FIG. 5 is a flowchart for explaining a method for generating a training data set for machine learning according to an embodiment of the present invention;

FIG. 6 is a view for explaining the process of generating a 3D model according to an embodiment of the present invention;

FIG. 7 is an exemplary view that shows the process of generating a 3D model according to an embodiment of the present invention;

FIG. 8 is a view for explaining the process of generating a 2D image according to an embodiment of the present invention; and

FIG. 9 is a block diagram that shows a computer system according to an embodiment of the present invention.

### DESCRIPTION OF THE PREFERRED EMBODIMENTS

Because the present invention may be variously changed and may have various embodiments, specific embodiments will be described in detail below with reference to the attached drawings.

However, it should be understood that those embodiments are not intended to limit the present invention to specific disclosure forms and that they include all changes, equivalents or modifications included in the spirit and scope of the present invention.

The terms used in the present specification are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

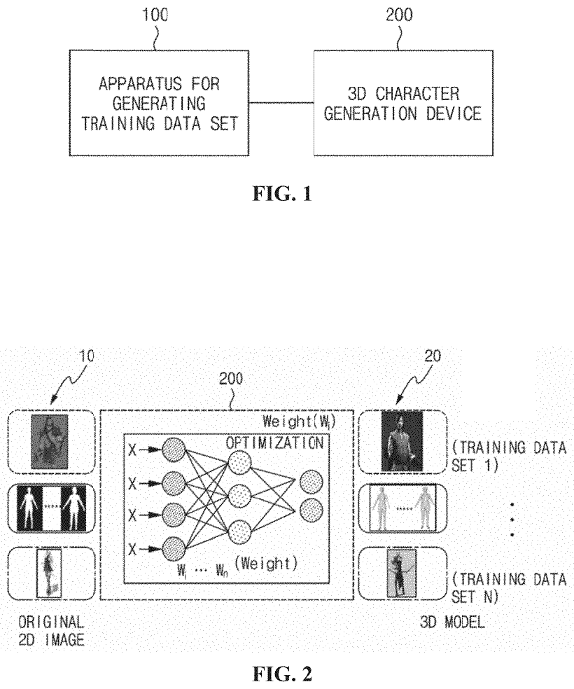

FIG. 1 is a view that schematically shows an environment in which an apparatus for generating a training data set for machine learning according to an embodiment of the present invention is applied.

As shown in FIG. 1, the apparatus for generating a training data set for machine learning according to an embodiment of the present invention (hereinafter, referred to as ‘a training data set generation apparatus’) 100 may be included in a 3D character generation system.

The 3D character generation system may include the training data set generation apparatus 100 and a 3D character generation device 200. Also, the training data set generation apparatus 100 may generate a large number of training data sets, and the 3D character generation device 200 may perform supervised learning using the training data sets generated by the training data set generation apparatus 100.

The 3D character generation device 200 is a device configured to receive an original 2D drawing and to generate a 3D character corresponding thereto. Here, the 3D character generation device 200 should perform learning in advance in order to infer a 3D character from the input original 2D drawing.

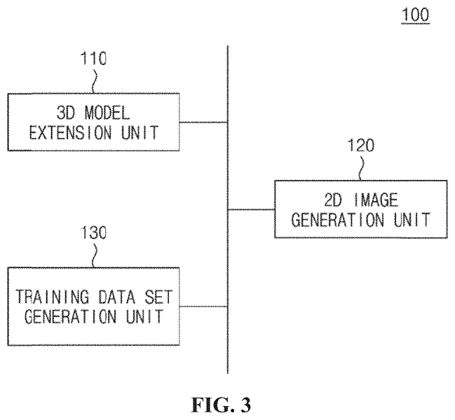

FIG. 2 is a view that shows a supervised learning process for generating a 3D character from an original 2D drawing.

The supervised learning process aims to configure a deep-learning network and optimize parameters (Weight, Wᵢ) so as to be suitable for training data sets. As shown in FIG. 2, supervised learning requires training data sets, each of which is configured with an original 2D image 10 and a 3D model 20.

The training data set is configured with the original 2D image 10 and the 3D model 20, which is a 3D character generated based on the original 2D image 10. In order to perform supervised learning for generating a 3D character, several thousands to hundreds of thousands of training data sets are required, but it is difficult to acquire such a huge number of training data sets, each of which is configured with a 2D image and a 3D model.

Accordingly, the training data set generation apparatus 100 according to an embodiment of the present invention generates a huge number of training data sets and thereby extends a seed-data learning DB, whereby the 3D character generation device 200 may perform supervised learning based on the extended seed-data learning DB.

The 3D character generation device 200, which performs supervised learning by performing the process shown in FIG. 2, may receive an original 2D drawing and automatically generate a 3D character based on the received original 2D drawing. Here, the original 2D drawing is a 2D image from which a 3D character is generated, and the 3D character is a stereoscopic character generated so as to correspond to the original 2D drawing. The original drawing may be drawn by a key animator, and the generated 3D character may be used in various fields, such as those of gaming, animations, VR, AR, and the like.

Here, the 3D character generation device 200 may generate the shape and texture information of the 3D character corresponding to the original 2D drawing using a machine learning engine. Here, the shape information may be 3D character mesh information configured with vertices, edges, and the like, and the texture information may be color information, which is defined as a diffuse map, a normal map, a specular map, or the like.

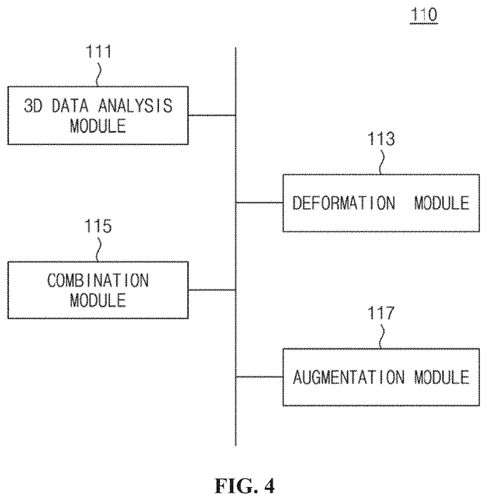

Hereinafter, the configuration of an apparatus for generating a training data set for machine learning according to an embodiment of the present invention will be described in detail with reference to FIG. 3 and FIG. 4.

FIG. 3 is a block diagram that shows the configuration of an apparatus for generating a training data set for machine learning according to an embodiment of the present invention.

As shown in FIG. 3, the training data set generation apparatus 100 includes a 3D model extension unit 110, a 2D image generation unit 120, and a training data set generation unit 130.

The 3D model extension unit 110 generates a 3D model for a deformed 3D character based on 3D data pertaining to the 3D character. The 3D model extension unit 110 may generate a 3D model for the 3D character in the training data set for machine learning.

The 3D model extension unit 110 may generate multiple 3D models by making use of one or more of the 3D models, corresponding to the seed data, as 3D data. Here, the 3D model extension unit 110 segments the 3D data into multiple segment models and deforms the segment models, thereby generating a 3D model for a deformed 3D character.

When 3D data is mapped to a dummy model corresponding to the 3D character through skinning, the 3D model extension unit 110 may augment the 3D model using skinning information. Also, the 3D model extension unit 110 may augment the 3D model by applying 2D augmentation to the texture of the 3D model.

The 3D model extension unit 110 may include multiple modules, as shown in FIG. 4.

FIG. 4 is a block diagram that shows the configuration of a 3D model extension unit according to an embodiment of the present invention.

As shown in FIG. 4, the 3D model extension unit 110 may include a 3D data analysis module 111, a deformation module 113, a combination module 115, and an augmentation module 117.

The 3D data analysis module 111 may segment 3D data into multiple segment models. Here, the 3D data analysis module 111 may classify 3D data based on the multiple parts of a 3D character, and may generate segment models for the respective parts by segmenting the 3D data.

For example, when the 3D character is a human character that wears a top, bottoms, and shoes, the 3D character analysis module 111 may classify the 3D character into parts corresponding to the top, the bottoms, the accessories, and the body by analyzing 3D data pertaining to the 3D character. Then, the 3D data analysis module 111 may generate segment models for the respective parts corresponding to the top, the bottoms, the accessories, and the body and store the segment models. Here, the accessories may be items other than the top and the bottoms worn on the body, and may include shoes, a hat, jewelry, and the like.

For the convenience of description, the 3D character has been described as a human character wearing a top, bottoms, and shoes (accessories). However, without limitation to this example, the 3D character may be a human character that does not wear clothes or accessories, an animal character, or the like, and the type and characteristics of the 3D character are not limited to these examples.

The deformation module 113 may generate a deformed model by deforming at least one of the segment models. Here, the deformation module 113 may deform a portion of the segment model, and may generate a deformed model by deforming at least one of the size and the pattern of a part of the 3D character.

The deformation module 113 selects at least one of the segment models for the respective parts corresponding to the top, the bottoms, the accessories, and the body, and may generate a deformed model by deforming the selected segment model.

For example, the deformation module 113 selects segment models corresponding to the top and the accessories, calls the segment model corresponding to the top and modifies the same from a long-sleeved top to a short-sleeved top, and calls the segment model corresponding to the accessories and puts a pattern on the shoes.

Here, the deformation module 113 may deform the segment model manually or using a vision technique, such as parametric deformation or the like, but the method used when the transformation module 113 deforms the segment model is not limited thereto.

The combination module 115 may generate a 3D model corresponding to the deformed 3D character using the segment models including one or more deformed models.

Here, when 3D data is mapped to the dummy model through skinning, the combination module 1150 may combine the segment models using skinning information.

When the deformation module 113 deforms the segment models corresponding to the top and the accessories, the combination module 115 combines the deformed model corresponding to the top, the deformed model corresponding to the accessories, and the segment models corresponding to the bottoms and the body, thereby generating a 3D model corresponding to the deformed 3D character. Here, the generated 3D model may be a 3D character in which the top worn by the 3D character corresponding to the seed is modified from a long-sleeved top to a short-sleeved top and in which a pattern is put on the shoes of the 3D character.

The augmentation module 117 augments the 3D model, which is generated in such a way that the combination module 115 combines the segment models including one or more of the deformed models, thereby generating an augmented 3D model. The augmentation module 117 may augment the 3D model, generated by the combination module 115, and augment the 3D model based on bone animation.

When 3D data is mapped to a dummy model through skinning, the augmentation module 117 may use skinning information for augmentation. When the generated 3D model is posed in various postures by changing the joints thereof, the body may be changed using the skinning information. Because the clothes worn on the body are deformed in response to the movement of the body, the augmentation module 117 may generate an augmented 3D model by changing the posture of the body.

Also, the augmentation module 117 applies the existing 2D augmentation to the texture of the 3D model, thereby generating an augmented 3D model. The augmentation module 117 applies various types of 2D augmentation, such as changing a color, adding noise, cropping, and the like, to the texture of the 3D model, thereby augmenting the 3D model. Here, the types of 2D augmentation are not limited to these examples. For example, the augmentation module 117 may augment the 3D model by generating a variously changed 3D model by changing the color of clothes worn on the 3D model.

Referring again to FIG. 3, the 2D image generation unit 120 generates a 2D image corresponding to the generated 3D model. Here, the 2D image is a 2D image for an original 2D drawing in a training data set for machine learning, and the 2D image generation unit 120 may generate an original drawing, corresponding to the 3D model generated by the 3D model extension unit 110, as a 2D image.

Here, the 2D image generation unit 120 performs multi-view rendering on the 3D model, thereby generating multiple 2D images corresponding to the 3D model. Because the 2D image generation unit 120 according to an embodiment of the present invention generates 2D images corresponding to the 3D model through multi-view rendering based on a cartoon, 2D images may be generated more efficiently than when using a method in which a drawing for the 3D model is manually generated.

Also, the 2D image generation unit 120 performs texture-preprocessing on the 3D model and applies Cel Shading thereto, thereby generating a 2D image corresponding to the 3D model.

The training data set generation unit 130 generates a training data set for machine learning, through which a 3D character is generated from a 2D image, using the 2D image and the 3D model.

The training data set generation unit 130 may generate a training data set for machine learning, which is a pair comprising the 2D image generated by the 2D image generation unit 120 and the 3D model corresponding thereto, among the 3D models generated by the 3D model extension unit 110.

The training data set generation unit 130 may store the generated training data set in the seed-data learning DB or input the same to the 3D character generation device 200 for supervised learning of the 3D character generation device 200. Here, the seed-data learning DB is a database in which a 3D model corresponding to an initial 3D character and a 2D image corresponding to the 3D model are stored, and the apparatus 100 for generating a training data set according to an embodiment of the present invention may extend the seed-data learning DB by performing the 3D model extension process and the 2D image generation process.

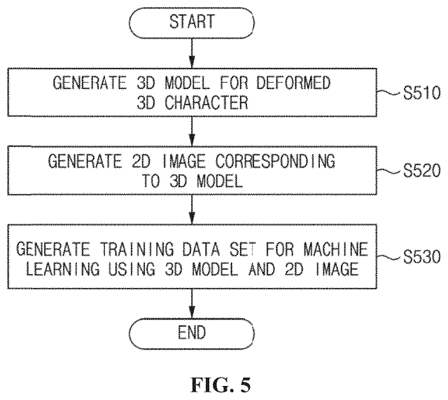

Hereinafter, a method for generating a training data set, performed by an apparatus for generating the training data set for machine learning, according to an embodiment of the present invention will be described in detail with reference to FIGS. 5 to 8.

FIG. 5 is a flowchart for explaining a method for generating a training data set for machine learning according to an embodiment of the present invention.

First, the training data set generation apparatus 100 generates a 3D model for a deformed 3D character at step S510.

The training data set generation apparatus 100 may generate a 3D model for a deformed 3D character based on 3D data pertaining to the 3D character. Here, the 3D data pertaining to the 3D character may be any one of 3D models for the 3D character that is a seed, and the training data set generation apparatus 100 may deform the 3D character and generate a 3D model for the deformed 3D character.

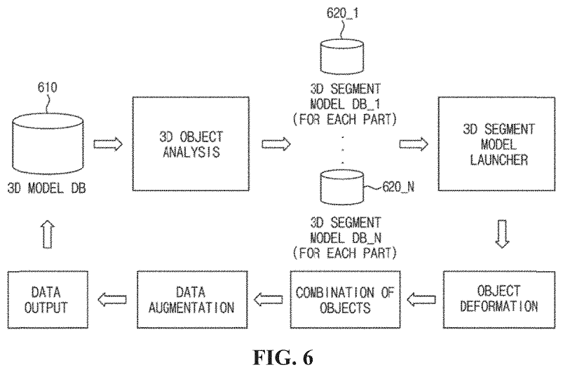

FIG. 6 is a view for explaining the process of generating a 3D model according to an embodiment of the present invention.

As shown in FIG. 6, the training data set generation apparatus 100 extracts a 3D model from one or more 3D models, which are stored in a 3D model DB 610, as 3D data. Then, the training data set generation apparatus 100 performs 3D object analysis for the 3D data, thereby segmenting the 3D data into multiple segment models.

For example, when the extracted 3D data is 3D data pertaining to a human character, the training data set generation apparatus 100 may segment the 3D data into segment models corresponding to a top, bottoms, accessories, and a body. Then, the training data set generation apparatus 100 may store the segment models in 3D segment model DBs 620 for the respective parts.

Here, when group information for each part is included in the 3D model, the training data set generation apparatus 100 performs 3D object analysis based on the group information, thereby generating segment models. For example, the training data set generation apparatus 100 may segment the 3D model into multiple segment models based on the group information (g) in an OBJ file.

For the convenience of description, the training data set generation apparatus 100 has been described as segmenting the 3D data into segment models corresponding to a top, bottoms, accessories, and a body, but without limitation thereto, the training data set generation apparatus 100 may generate segment models by segmenting the 3D data into parts such as an upper body, a lower body, arms, legs, a torso, and the like. Here, the types and number of parts are not limited to these examples.

After the segment models are generated by performing 3D object analysis, the 3D segment model launcher of the training data set generation apparatus 100 calls the segment models one by one from the respective 3D segment model DBs 620, and may then perform object deformation on the called segment models.

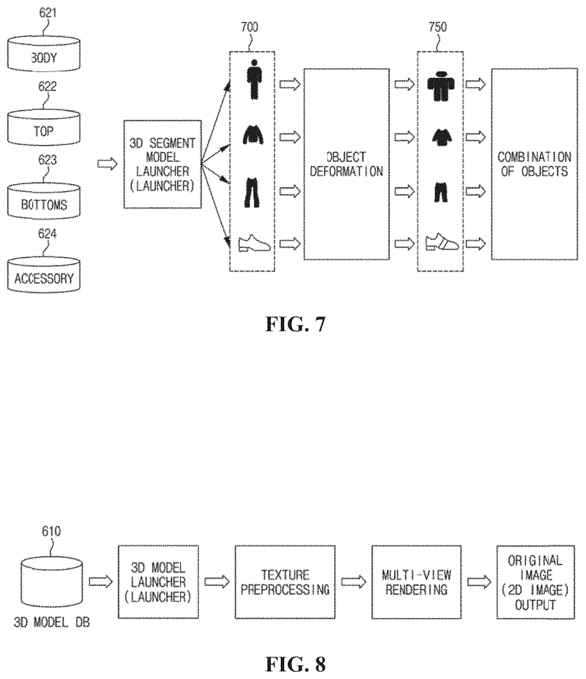

FIG. 7 is an exemplary view that shows the process of generating a 3D model according to an embodiment of the present invention.

As shown in FIG. 7, assuming that the training data set generation apparatus 100 stores the segment models for a body, a top, bottoms, and accessories in a 3D segment model DB for a body 621, a 3D segment model DB for a top 622, a 3D segment model DB for bottoms 623, and a 3D segment model DB for accessories 624, respectively, the 3D segment model launcher may call one segment model from each of the 3D segment model DB s 621 to 624.

Then, the training data set generation apparatus 100 may generate deformed models 750, which are deformed 3D objects, by deforming the called segment models 700. Here, the training data set generation apparatus 100 may deform one or more of the called segment models 700 or all of the called segment models.

For example, assume that the called segment models 700 are a 3D segment model for a standard body, a 3D segment model for a long-sleeved shirt, a 3D segment model for long trousers, and a 3D segment model for plain shoes. The training data set generation apparatus 100 may deform the 3D segment model for the standard body, called from the 3D segment model DB for a body 621, into a body shape that is short and fat, deform the 3D segment model for the long-sleeved shirt, called from the 3D segment model DB for the top 622, into a short-sleeved shirt, or deform the 3D segment model for long trousers, called from the 3D segment model DB for bottoms 623, into short trousers.

As described above, the training data set generation apparatus 100 may generate a deformed model 750 by changing the size or the pattern of a part corresponding to the called segment model 700.

For example, the training data set generation apparatus 100 may generate a deformed model 750 by putting a pattern on the 3D segment model for the plain shoes, called from the 3D segment model DB for accessories 624, or changing the old pattern.

After it generates the deformed models 750, the training data set generation apparatus 100 may generate a 3D model for the deformed 3D character by combining the generated deformed models 750. Here, the training data set generation apparatus 100 may generate a 3D model as a new model for the deformed 3D character by combining one or more of the deformed models 750 with the segment models.

Then, the training data set generation apparatus 100 may generate an augmented 3D model by performing data augmentation for the generated 3D model, as shown in FIG. 6, and may output the augmented 3D model or store the same in the 3D model DB 610. Here, the augmented 3D model may be in the form of an OBJ file, or may be in the form of a FBX file, which contains skinning information for animation or the like. Also, the finally generated 3D model may be stored in a separate DB for deformed 3D characters, or may be stored in the 3D model DB 610 so as to be reused when the training data set is scaled up.

After it generates the 3D model for the deformed character, the training data set generation apparatus 100 generates a 2D image corresponding to the generated 3D model at step S520.

The training data set generation apparatus 100 may generate multiple 2D images corresponding to the 3D model generated at step S510. The training data set generation apparatus 100 performs multi-view rendering on the 3D model, thereby generating three 2D images viewed from three sides, that is, viewed from the front (0 degrees), side (90 degrees), and back (180 degrees). For the convenience of description, an example in which 2D images respectively viewed from the front, side, and back are generated has been described, but without limitation to this example, the training data set generation apparatus 100 may generate 2D images from various points of view.

Also, the training data set generation apparatus 100 may arrange one or more calibrated cameras and perform rendering in the form of a cartoon. The training data set generation apparatus 100 may apply Cel Shading to the 3D model. Here, the values of parameters for setting the position of lighting, the thickness of a line, and the like, which are used when Cel Shading is applied, may be set such that the 3D model looks like an original drawing.

Accordingly, a cartoon-style 2D image corresponding to the 3D model may be generated. Here, ‘Cel Shading’ is a type of non-photorealistic rendering and is referred to as Cel-Shaded animation, toon shading, or toon rendering. The application of Cel Shading may impart the effect of a hand-drawn look.

FIG. 8 is a view for explaining the process of generating a 2D image according to an embodiment of the present invention.

As shown in FIG. 8, the 3D model launcher of the training data set generation apparatus 100 may call any one 3D model from among pieces of 3D data stored in a 3D model DB 610. Here, the called 3D model may be a 3D model generated by the 3D model extension unit 110 of the training data set generation apparatus 100.

When the called 3D model has a texture similar to an actual image, the training data set generation apparatus 100 performs texture-preprocessing and performs multi-view rendering, thereby generating a 2D image (original drawing). Here, the training data set generation apparatus 100 performs texture-preprocessing for simplifying a 24 (or higher)-bit 3D model such that the 2D image looks like a hand-drawn image.

Then, the training data set generation apparatus 100 may output the multi-view rendered image as a 2D image or store the same. Here, the multi-view rendered image means an original 2D drawing corresponding to the 3D model.

For the convenience of description, the training data set generation apparatus 100 has been described as generating a 3D model for a deformed character and then generating a 2D image for the 3D model, but without limitation thereto, the training data set generation apparatus 100 may separately perform the process of generating a 3D model and the process of generating a 2D image corresponding to the 3D model.

Finally, the training data set generation apparatus 100 generates a training data set for machine learning at step S530 based on the 3D model and the 2D image.

The training data set generation apparatus 100 generates a training data set, which is a pair comprising the 3D model called by the 3D model launcher in the process of generating a 2D image and the 2D image generated by performing multi-view rendering on the corresponding 3D model.

Here, machine learning, for which the training data set is generated, is machine learning for receiving a 2D image and generating a 3D character corresponding thereto, and the training data set generation apparatus 100 generates a training data set configured with a pair comprising a 2D image and a 3D model.

As described above, the training data set generation apparatus 100 according to an embodiment of the present invention may generate a training data set for the 3D character generation device 200, which generates a 3D character based on an original 2D drawing. The training data set generation apparatus 100 extends a seed-data learning DB by extending 3D models corresponding to 3D characters and 2D data corresponding to the original drawing, thereby enabling the 3D character generation device 200 to perform supervised learning using a large number of training data sets.

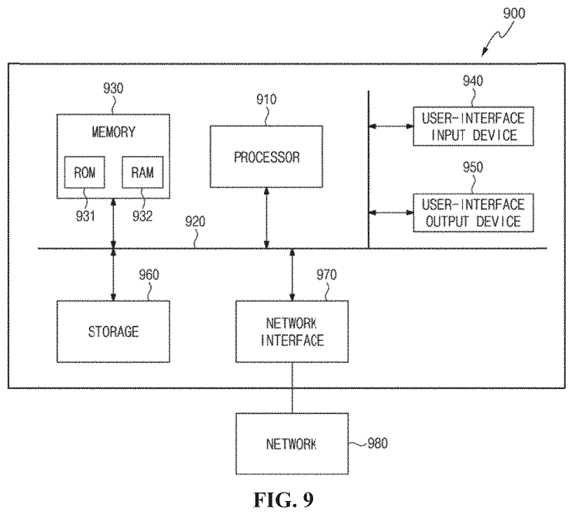

FIG. 9 is a block diagram that shows a computer system according to an embodiment of the present invention.

Referring to FIG. 9, an embodiment of the present invention may be implemented in a computer system 900 including a computer-readable recording medium. As shown in FIG. 9, the computer system 900 may include one or more processors 910, memory 930, a user-interface input device 940, a user-interface output device 950, and storage 960, which communicate with each other via a bus 920. Also, the computer system 900 may further include a network interface 970 connected to a network 980. The processor 910 may be a central processing unit or a semiconductor device for executing processing instructions stored in the memory 930 or the storage 960. The memory 930 and the storage 960 may be various types of volatile or nonvolatile storage media. For example, the memory may include ROM 931 or RAM 932.

Accordingly, an embodiment of the present invention may be implemented as a nonvolatile computer-readable storage medium in which methods implemented using a computer or instructions executable in a computer are recorded. When the computer-readable instructions are executed by a processor, the computer-readable instructions may perform a method according to at least one aspect of the present invention.

According to the present invention, a large number of training data sets for machine learning is generated, whereby a seed-data learning DB may be extended.

Also, according to the present invention, it is possible to generate training data sets to be used when 3D objects are reconstructed using deep learning.

Also, according to the present invention, a 3D character may be automatically created based on an original 2D drawing.

As described above, the apparatus and method for generating a training data set for machine learning according to the present invention are not limitedly applied to the configurations and operations of the above-described embodiments, but all or some of the embodiments may be selectively combined and configured, so that the embodiments may be modified in various ways.

What is claimed is:

1. A method for generating a training data set for machine learning, performed by an apparatus for generating the training data set for machine learning, comprising:
generating a 3D model for a deformed 3D character based on 3D data pertaining to the 3D character;
generating at least one 2D image corresponding to the generated 3D model; and
generating the training data set for machine learning, through which the 3D character is generated from the 2D image, using the 2D image and the 3D model.

2. The method of claim 1, wherein generating the 3D model for the deformed 3D character is configured to segment the 3D data into multiple segment models and to deform the segment models, thereby generating a deformed 3D model of the 3D character.

3. The method of claim 2, wherein generating the 2D image is configured to perform multi-view rendering on the 3D model, thereby generating the at least one 2D image corresponding to the 3D model.

4. The method of claim 1, wherein generating the 3D model for the deformed 3D character comprises:
segmenting the 3D data into multiple segment models;
generating at least one deformed model by deforming at least one of the segment models; and
generating the 3D model so as to correspond to the deformed 3D character using the segment models including the at least one deformed model.

5. The method of claim 4, wherein segmenting the 3D data into the multiple segment models is configured to classify the 3D data based on multiple parts of the 3D character and to generate the segment models for the respective parts by segmenting the 3D data into the segment models so as to match the multiple parts.

6. The method of claim 5, wherein generating the at least one deformed model is configured to generate the deformed model by modifying at least one of a size and a pattern of the part of the 3D character.

7. The method of claim 6, wherein generating the 3D model so as to correspond to the deformed 3D character is configured to generate the single 3D model by combining the segment models including the at least one deformed model and to augment the generated single 3D model, thereby generating an augmented 3D model.

8. The method of claim 1, wherein generating the 3D model for the deformed 3D character is configured to augment the 3D model using skinning information when the 3D data is mapped to a dummy model corresponding to the 3D character through skinning.

9. The method of claim 1, wherein generating the 3D model for the deformed 3D character is configured to augment the 3D model by applying 2D augmentation to a texture of the 3D model.

10. The method of claim 1, wherein generating the 2D image is configured to generate the 2D image corresponding to the 3D model by performing texture-preprocessing on the 3D model and by applying Cel Shading to the 3D model on which texture-preprocessing is performed.

11. An apparatus for generating a training data set for machine learning, comprising:
a 3D model extension unit for generating a 3D model for a deformed 3D character based on 3D data pertaining to the 3D character;
a 2D image generation unit for generating at least one 2D image corresponding to the generated 3D model; and
a training data set generation unit for generating the training data set for machine learning, through which the 3D character is generated from the 2D image, using the 2D image and the 3D model.

12. The apparatus of claim 11, wherein the 3D model extension unit segments the 3D data into multiple segment models and generates a deformed 3D model of the 3D character by deforming the segment models.

13. The apparatus of claim 12, wherein the 2D image generation unit performs multi-view rendering on the 3D model, thereby generating the at least one 2D image corresponding to the 3D model.

14. The apparatus of claim 11, wherein the 3D model extension unit comprises:
a 3D data analysis module for segmenting the 3D data into multiple segment models;
a deformation module for generating at least one deformed model by deforming at least one of the segment models; and
a combination module for generating the 3D model corresponding to the deformed 3D character using the segment models including the at least one deformed model.

15. The apparatus of claim 14, wherein the 3D data analysis module classifies the 3D data based on multiple parts of the 3D character and segments the 3D data into the segment models so as to match the multiple parts, thereby generating the segment models for the respective parts.

16. The apparatus of claim 15, wherein the deformation module generates the deformed model by modifying at least one of a size and a pattern of the part of the 3D character.

17. The apparatus of claim 16, wherein the 3D model extension unit further comprises:
an augmentation module for generating an augmented 3D model by augmenting the 3D model, which is generated in such a way that the combination module combines the segment models including the at least one deformed model.

18. The apparatus of claim 11, wherein the 3D model extension unit augments the 3D model using skinning information when the 3D data is mapped to a dummy model corresponding to the 3D character through skinning.

19. The apparatus of claim 11, wherein the 3D model extension unit augments the 3D model by applying 2D augmentation to a texture of the 3D model.

20. The apparatus of claim 11, wherein the 2D image generation unit generates the 2D image corresponding to the 3D model by performing texture-preprocessing on the 3D model and by applying Cel Shading to the 3D model, on which texture-preprocessing is performed.
